(19) United States
(12) Patent Application Publication
(10) Pub. No.: US 2014/0265167 A1
(43) Pub. Date: Sep. 18, 2014

(54) HANDS FREE CARRIAGE AND HARNESS ASSEMBLY HAVING MULTIPLE MODES OF TOWING A LOAD

(71) Applicant: Mauricio Mejia, Denver, CO (US)

(72) Inventor: Mauricio Mejia, Denver, CO (US)

(21) Appl. No.: 13/835,776

(22) Filed: Mar. 15, 2013

(51) Int. Cl. B62B 1/10

(52) U.S. Cl. CPC B62B 1/10
USPC 280/1.5

(57) ABSTRACT

A carriage assembly, harness and towing assembly is disclosed, which allows for significant freedom of movement for a user. The carriage preferably comprises at least a single, two-wheel axis and at least one motion damping device provided with a plurality of coupling members attaching the carriage to the harness. One object of the disclosure is to provide an apparatus that allows a user to comfortably tow a child or other tow load while participating in a variety of exercise or general travel-related activities.

### FIELD OF THE INVENTION

The present invention relates generally to carriages and towing devices. More specifically, it relates to a carriage that may accommodate a child and/or cargo, and may be selectively attached to a user for moving the carriage while the user is in motion, and by one of several modes described herein.

### BACKGROUND

A variety of devices are known for towing humans in a cart or carriage. Among these devices are horse drawn sulkies, rickshaws, and towed carriages for attachment to bicycles. These devices are generally suited for constant linear motion with little consideration given to the forces encountered in various accelerations in both the horizontal, vertical and tangential directions. Typically, one or more rigid members are applied to connect the carriage to the host user. These members create a direct connection between the user and the carriage which is necessary to maintain a constant distance between the two. This rigidity of the structure provided in prior art devices, however, generates complications with steering and negotiating sharp hills and corners, particularly for use by a user while jogging or walking.

Additionally, prior art devices call for a rigid carriage system with little impact absorption outside of what may be achieved by tires, suspension systems or seat materials. The lack of dampening in these devices allows for the natural yet unpredictable motion of running or walking to be imparted upon the carriage, creating an uncomfortable and potentially unsafe ride for the passenger. Likewise, the various forces applied to the carriage through the ground or other surface on which the carriage rides are translated to the user. This results in an uncomfortable experience for the host user and an uncomfortable ride for the passenger(s).

### SUMMARY OF THE INVENTION

Thus there is a need to provide a carriage and a harness for pulling or towing the carriage which addresses these and other problems associated with prior art devices, and that otherwise provides a user with the ability to tow loads of varying weights while exercising, such as during walking, running, hiking, skating, skiing, shopping or any other desired activity. There is further the need to provide a harness that is both comfortable to the user and allows a wide range of motion during travel and accommodates the towing of a carriage carrying one or more persons and/or other tow loads. There is even a further need to provide an improved carriage assembly, which reduces the impact of the motion of the user on the carriage and vice versa, and provides for the overall comfort and stability of the carriage.

One aspect of the present disclosure is to provide a carriage which may be attached to a user while still allowing for complete freedom of movement and minimize the impacts of the carriage's natural movement on the user as well as reducing the impacts of the natural motion of the user upon the carriage. The following are incorporated by reference herein in their entireties: U.S. Pat. No. 5,062,651 entitled “Jogging Baby Carriage”; U.S. Pat. No. 2,343,019 entitled “Tractor-Trailer Combination”; and U.S. Pat. No. 660,598 entitled “Bicycle-Tender.”

Another aspect of the present disclosure is to provide a safe and comfortable ride for a passenger. The following are incorporated by reference herein in their entireties: U.S. Pat. No. 7,007,956 entitled “Harness Device, Kit and Method of Using Same”; U.S. Des. Pat. No. 367,142 entitled “Body Harness for Towing”; and U.S. Pat. No. 4,335,875 entitled “Jogging Rope Harness.”

Another aspect of the present disclosure is to provide a system which allows the user to incorporate the carriage assembly in a variety of exercise or general travel/recreational activities, thus allowing the user to engage in activities that would otherwise be impractical, as well as conferring the benefits of outdoor exposure and stimulation upon the passenger.

Yet another aspect of the present disclosure is to provide such a carriage of sturdy, lightweight construction that will occupy minimal space when stowed or otherwise placed in storage.

One embodiment of the invention is directed to an assembly for moving a tow load by a user, comprising:

a harness or belt for attachment to a user;

a tow assembly for towing the carriage, the tow assembly coupled to at least one connection member and thereby to the harness or belt, the at least one connection member comprised of at least one telescoping, semi-resilient member;

a seat or platform supported by the frame assembly for accommodating a tow load;

at least two wheels; and

a frame assembly supported by the at least two wheels, wherein the at least two wheels define an area substantially devoid of mechanical apparatus associated with the carriage so as to avoid interfering with the movement of a user's legs there-between.

It will be appreciated by those skilled in the art that the concepts presented herein are applicable for use with a variety of other conveyances other than the carriage types listed above and/or described in the detailed description below, such as sleds, rickshaws, pedicabs, bicycle taxis, wagons, buggies and trailers, to name a few. Furthermore, the carriage as disclosed may include a number of embodiments for pulling behind a person on skates or on skis, including cross-country skis. Therefore, although the drawing figures depict a carriage with wheels, it is to be expressly understood that a modified carriage with runners, like the type associated with a sleigh, would operate with and is contemplated with the present invention. It is therefore to be understood that the present invention includes a variety of different versions or embodiments, and this Summary is not meant to be limiting or all-inclusive. That is, this Summary provides general descriptions of certain embodiments, but may also include more specific descriptions of certain other embodiments. Furthermore, the use of the terms carriage and/or harness, together or in conjunction with one another, is not intended to be limiting in any respect, and it is to be expressly understood that use of an equivalent device, alone or in conjunction with another device, consistent with the scope of the appended claims, is considered to be within the scope of the present disclosure.

Accordingly, various embodiments of the present invention are illustrated in the attached figures and described in the detailed description of the invention as provided herein and as embodied by the claims. For a detailed description of how these objects are accomplished by the present invention, reference should be made to the accompanying drawings and descriptive language that follows, as well as the appended claims.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

In the drawings:

FIG. 1 is a side elevation profile of the carriage assembly according to one embodiment of the present disclosure;

FIG. 2 is a top plan view of the embodiment shown in FIG. 1;

FIG. 3 is a top plan view of the connection members of the carriage assembly according to one embodiment of the present disclosure;

FIG. 4 is a perspective view of the carriage assembly and connection members according to another embodiment of the present disclosure;

FIG. 5a is a harness and attachment assembly according to one embodiment of the present disclosure;

FIG. 5b is a harness and attachment assembly according to one embodiment of the present disclosure;

FIG. 5c is a harness and attachment assembly according to one embodiment of the present disclosure;

FIG. 5d is a harness and attachment assembly according to one embodiment of the present disclosure;

FIG. 5e is a harness and attachment assembly according to one embodiment of the present disclosure; and

FIG. 5f is a harness and attachment assembly according to one embodiment of the present disclosure.

### DETAILED DESCRIPTION OF THE INVENTION

With reference to the specific drawing figures contained herein, the present disclosure is directed to components and apparatus generally related to a towed vehicle, herein referred to as a carriage, for towing a load or carrying a person(s) substantially as depicted and described herein, including various embodiments, subcombinations, and subsets thereof.

According to one specific embodiment, the disclosure comprises a carriage, a suspension system for the carriage, a harness for securing the carriage to a host, and a linkage between the carriage and the harness for towing the carriage behind the person wearing the harness during walking, jogging, cycling, skiing, skating, or other activity. According to various embodiments disclosed herein, the linkage between the harness and the carriage may be comprised of a combination of rigid, semi-rigid and non-rigid member(s), which may be fewer or greater on number than those depicted in the accompanying drawing figures, and which extend a specified length and in a specified orientation between the carriage to the harness as necessary for the desired activity and to prevent the movement of the carriage from disturbing the movement of the user, and vice versa.

Referring in detail to the drawing figures, several embodiments of the present disclosure are shown. In particular, FIGS. 1 and 2 show an assembly for towing a load, including but not limited to a person, the assembly comprising a harness 26, a coupling joint 16 and coupling members 14, which may be used to attach to and thereby tow a carriage 2 supported by framing supports 12 and at least two wheels 10. According to the embodiment shown in FIGS. 1 and 2, the carriage is designed particularly for towing a child (not shown) and may further comprise a canopy or housing 4. Further apparatus, such as apparatus for restraining the child in the carriage or a mobile for providing entertainment to the child, may be included with the carriage shown in FIGS. 1 and 2 without departing from the spirit of the present disclosure.

Referring in detail to FIG. 1, the harness 26 is preferably worn by a user about the user's waist, as shown in the drawing figures. Alternatively, the harness may further comprise one or more straps to secure the waist harness to the user's shoulders, arms or chest. In one alternative embodiment, the harness only attaches to the user's shoulders, arms or chest and not the user's waist. The harness is preferably adjustable to adjust for a variety of sizes of users, and may be secured to the user by a variety of attachment devices, including buckles, clips, pins, clasps, snaps, buttons, tying cords, cinch straps, Velcro straps, or other attachment devices known to those of skill in the art.

Still referring to FIG. 1, the coupling joint 16 and coupling members 14 are oriented to permit the user to engage in a variety of movements (walking, jogging, running, cycling, skiing, skating, etc.) without unnecessary interference. In this manner, the coupling joint 16 is preferably positioned towards the center of the user's back once the harness has been secured to the user. Also preferably, coupling members 14 are linear and connect the coupling joint 16 to the carriage 2 (as shown in FIG. 1). This arrangement assists in transferring the tow load to a central location relative to both the user's height and breadth, and facilitates ease of movement of the carriage 2 when the user is rounding a corner, making a slight turn or changing from a flat surface to an inclined or declined surface. Alternatively, the coupling joint 16 may be of a different configuration, such as those shown and described in connection with FIGS. 5a-f.

Also alternatively, the coupling members 14 may have a chamfer, deflection or bend, such as the coupling members depicted in FIG. 2. In this embodiment, the coupling members 14 serve to provide stability about lateral planes as the carriage is being towed by the user. This stability is created by transferring a portion of the towing force outward from the central axis defined by the direction of the user's movement, which in turn permits the carriage 2 to have a greater ability to pivot when the path of the carriage changes, such as when the user is rounding a corner. In one embodiment, the coupling members may have a first or a second flexible element 18, whereby the flexible element permits the coupling member to achieve greater flexibility or alternatively absorb stress imparted on the coupling members when the carriage is being towed. For example, flexible elements 18 may be formed from using a flexible material in at least one portion of the coupling members, such as with a living hinge. In other embodiments, the number of flexible elements 18 may be greater than two, but preferably are symmetrical with respect to each of the coupling members 14 present in the embodiment selected.

Referring still to FIG. 2, the carriage 2 is preferably supported by framing supports 12 which distribute the load of the carriage to two or more wheels 10. The framing supports 12 are preferably oriented to the lateral sides of the carriage 2 and extend in a direction generally away from the area beneath the carriage 2, thereby eliminating the possibility of interference with the user's legs while the user is in motion. In this respect, the preferred embodiment of the present disclosure comprises a carriage support assembly (framing supports, wheels and carriage) that provides an area behind the user's legs that is substantially devoid of mechanical parts. This aspect is particularly important for user's who are jogging, running, skiing or engaged in other movements that, if interfered with, could cause injury to the user and/or to any occupant of the carriage 2.

Wheels 10 may be comprised of a variety of materials, and may be of a variety of sizes depending on the carriage and the type of load to be towed. In general, there are at least two wheels 10 having substantially the same diameter and oriented to permit rotation in a generally parallel plane with respect to the other wheel(s) of the carriage assembly. The wheels 10 are preferably approximately 20-48 inches in diameter, and more preferably approximately 30-36 inches in diameter. The carriage 2 may alternatively be supported by a third wheel (not shown) that is positioned on the side of the carriage 2 opposite the user and generally in a position central to the other two wheels 10 shown in FIG. 2. Additional numbers of wheels may also be included depending on the size of the carriage.

Referring now to FIG. 3, the coupling members 14 may further comprise dampening members 22, which serve to dampen the horizontal forces caused by the carriage 2 on the user and vice versa. In this embodiment, the dampening members 22 are oriented to dampen generally horizontal forces on either horizontal side of a post 30 positioned at or near each distal end of the coupling members 14. The dampening members 22 may be comprised of one or more devices for biasing, such as a spring or piston or pneumatically resistive chamber, or may be comprised of solid material having generally absorbent properties, such as an elastomeric material. In use, the dampening members are positioned on each horizontal side of posts 30, which are the elements of the coupling members 1 attached to coupling joint 16. As the user is in motion, the force is translated from the harness 26 to the coupling joint 16 to the posts 30 of the coupling members 14. To accommodate for sudden or sharp movements (such as during beginning and suddenly stopping movement), the dampening members 22 resist the movement and dampen the force imparted on the posts 30 relative to the coupling members 14. As the dampening members 22 are located in both horizontal directions of the posts 30, the dampening effect occurs when the movement is imparted in either forward or a backward direction (relative to the carriage). Similarly, the dampening members 22 positioned on either side of the posts 30 closest to the carriage 2 dampen the forces that are translated from the carriage during its movement.

According to one alternative embodiment shown in FIG. 4, coupling members 14 may further comprise at least one telescoping assembly, wherein a first length of coupling member 14 is partially contained within a second length of coupling members 14, and wherein the first length is slightly narrower in width than the second length of coupling members 14 to permit the first length to be telescopically engaged with the second length. The telescoping assembly may be comprised of more than a first and a second telescoping section. The coupling members 14 may further comprise an adjustable screw, such as a set screw, for retaining the position of the first length relative to the second length of the coupling members 14 once the desired height has been set. This telescopic engagement permits a user to adjust the height and/or orientation of the coupling members 14, thereby allowing the coupling members 14 to adjust to varying heights of users and preference of the user in where they position the harness 26. In yet another alternative embodiment, this telescopic engagement may include a friction fit between the first and second length of the coupling members to allow the lengths to move relative to each other during use. This engagement further permits users to configure the height of the coupling member 14 before use, but allows the height of the coupling member 14 to automatically adjust during use. In this embodiment, the first length may further comprise a flange on one distal end and the second length may further comprise a lip having a diameter slightly narrower than the flange to prevent the first length becoming disengaged from the second length during use.

Still referring to FIG. 4, the dampening effect described above in relation to FIG. 3 may be further imparted on the coupling members 14 as shown in FIG. 4 by providing a post 30 which is surrounded by dampening member 33. Thus, any direction of movement (whether horizontal or not) would be dampened by the presence of the dampening member 33 surrounding the post 30.

As discussed above, harness 26 is preferably constructed as a waist belt that is adjustable to accommodate a variety of users. In many forms of exercise, it is desirable if not essential to have full range of motion. Thus, harness 26 is designed to contact the user only around the waist while providing sufficient comfort via the material and positioning of the harness 26 so as not to interfere with the user's arms, hips or other moving body parts when the apparatus is in use. According to one embodiment, the harness further comprises a fastening mechanism that permits a user to unfasten the harness without removing the harness 26 from the user's waist, and rotate the harness 26 so that the user is facing the carriage (as opposed to having the user's back to the carriage 2). In this embodiment, the user has the option of pushing the carriage as opposed to pulling or towing the carriage behind him or her. This may be particularly advantageous for a user towing a small child, to permit the user to face the child for a portion of its use.

The harness 26 preferably has a large enough width to accommodate attachment of the coupling joint 16, which may be secured to the harness 26 by threading a portion of the harness 26 through a slit in the surface of the coupling joint 16, by securing a pin through a sleeve in the harness 26 and a slot in the coupling joint 16, or by other means known to those of skill in the art.

A number of alternate embodiments of a harness, coupling joint and coupling member (i.e., attachment assembly) configurations are shown in FIGS. 5a-f. According to the embodiment shown in FIGS. 5a-f, a variety of alternate embodiments for the connection members and/or dampening members is also shown. According to these embodiments, a user may engage in a variety of movements without restriction to either the movement of the waist/shoulders/chest, and the user may freely use their arms in a “hands free” manner without any interference from either the harness, connection member(s) and/or dampening member(s). Thus, according to the several embodiments shown in FIGS. 5a-f, there is provided an attachment assembly that permits the user to move in a variety of manners, including but not limited to, pivot, while attached to a carriage assembly, all the while free of restriction or interference with the mechanical parts of the carriage assembly.

Referring now in detail to FIG. 5a, an assembly is shown which comprises a harness 26, connection member 14 and a plurality of dampening members 41, 46. In this embodiment, the harness 26 is preferably secured around the user's waist or chest. The harness 26 may be adjustable as described above. The connection member 14 is preferably a single member which attaches to a carriage assembly (not shown). First dampening member 46 is used to connect the connection member 14 to the harness 26. In one embodiment, dampening member 46 is comprised of a rotational dampening member, such as a cylindrical/rotational hinge, further comprising one or more biasing and/or dampening elements within the cylindrical body of dampening member 46. Dampening member 46 is further connected by two linkages 45 to additional dampening members 41. The linkages 45 may be rigid, semi-rigid, resilient, semi-resilient, or may be a combination of the foregoing.

Dampening members 41 may be similar in nature to dampening member 46 as described above, or may provide dampening in alternate planes and/or directions from the dampening provided by dampening member 46. For example, and by way of illustration but not limitation, dampening members 41 may dampen movement of the carriage translated to the connection member 14 in a substantially vertical plane, whereas dampening member 46 may dampen forces translated to connection member 14 in a substantially horizontal plane. In this manner, the combination of dampening member 46 and dampening member 41 may act in concert, and cooperate to reduce the number and amplitude of forces experienced by the user while the carriage assembly is in movement.

Referring now to FIG. 5b, a further alternate embodiment of the present disclosure is shown. In this embodiment, an additional dampening member 44 is placed in series or in parallel to the dampening member 46 (described in relation to FIG. 5a). In further alternate embodiments, dampening element 44 is not substantially in series and/or in parallel with dampening member 46, but in a preferred embodiment, dampening members 44 and 46 are able to act in concert to ensure that both: (1) forces imparted on the connection member 14 by the carriage assembly (not shown) are not translated to the user; and (2) that forces and movements made by the user are not translated to the carriage assembly. According to this embodiment, there is a generally planar linkage 42 which connects dampening members 44, 46. This planar linkage 42 may independently rotate to a certain degree about its connection with dampening member 44 and independently rotate to a certain degree with respect to dampening member 46. Thus, in use, the assembly shown in FIG. 5b permits the forces caused from vertical movements of the connection member 14 to be rotationally dampened by dampening member 46, and vertical forces caused by the movement of the user and imparted to the harness 26 may be dampened by dampening member 44. It is expressly understood that variations of the number and location of dampening members and/or the location and orientation of the generally planar linkage 42 are considered within the scope of the present disclosure.

Referring now in detail to FIG. 5c, a further alternate embodiment of the present disclosure is shown. According to this embodiment, posts 30 and dampening members 22 (such as those described above in connection with FIG. 3) are further used to connect the harness 26 to the carriage assembly, by further way of connection member 14 and dampening member 46 (which is described above in relation to FIG. 5b). In this embodiment, the posts/dampening member 30/22 are further connected to the dampening member 46 by way of linkages 35. These linkages 35 may be rigid, semi-rigid, resilient or semi-resilient or any combination of the foregoing.

According to this embodiment, the benefits of the harness and attachment assembly include those benefits described above in relation to FIG. 3 (with respect to the posts/dampening members 30/22) and the benefits of the dampening members and associated operability described above in relation to FIG. 5b. In a further alternate embodiment, posts 30 may be replaced by a substantially spherical attachment member, such that the connection between the substantially spherical connection member and the harness is not only permitted to dampen forces in a generally horizontal plane, but also permits the generally spherical member to rotate about a vertical plane while the user is in motion. According to this embodiment, the attachment between the generally spherical connection member and the harness permits a user to ascend, descend, kneel, jump, bounce or other similar movement which would require a rotational or pivoting connection between the attachment assembly and the harness.

Referring now in detail to FIG. 5d, a further alternate embodiment is shown, which is similar in nature to the embodiment shown and described above in relation to FIG. 5c. According to this embodiment, the linkages 35 are arcuate in shape as depicted in FIG. 5d. Also according to this embodiment, the attachment assembly is oriented in a manner that further facilitates the benefit to a user in avoiding contact with any mechanical parts of the assembly. Furthermore, this configuration shown in FIG. 5d also facilitates the storage and/or transportation of the carriage assembly, or the attachment assembly (in the embodiment where the attachment assembly is selectively detached from the carriage assembly).

Referring now to FIGS. 5e and 5f, two further alternate embodiments of the present disclosure are shown. In FIG. 5e, the harness 26 is connected to the connection member 14 by an assembly comprising a post 56 a socket 52 and a generally spherical joint 54. The joint 54 may be inserted and received into socket 52 in a manner that avoids the joint 54 becoming separated from the socket while the carriage assembly is in use. For example, ball joints and other similar joints known to those of ordinary skill in the art are contemplated for use in this manner. The joint 54 may not only permit freedom of movement in a generally horizontal plane, but may also permit vertical movement as described above in connection with FIG. 5c. In this manner, FIG. 5e further provides the benefits described herein, while providing a simpler and less complex attachment assembly, which in turn will reduce the cost and improve the operation of the disclosure herein.

Referring now to FIG. 5f, a harness 26 is attached to a dampening member 46 which is further attached to coupling member 14. However, in this embodiment, coupling member 14 further has at least one hinge element 60 which is integral to the connection member 14. For example, but not limitation, the hinge element 60 may be a living hinge as described above, or may be a more complex hinge, such as a hinge that is embedded into a first portion and second portion of the connection member 14 (on either side of the hinge element). The living hinge embodiment may be comprised of a substantially similar material as the connection member 14, but in an alternate embodiment the combination of the connection member 14 and the hinge element 60 is composed of blended materials. For example, the hinge element 60 may be made of a material that is substantially more flexible than the material of the connection member 14. In this manner, the selection of the particular material for the hinge element 60 may be determinative of the degree of flexibility of the hinge element 60.

Variations on these described embodiments, including but not limited to combination with any of the dampening members, connection members, linkages, harnesses, posts, spherical connection members, joints, etc. described herein is specifically contemplated as part of the present disclosure.

According to a preferred embodiment, a canopy or housing 4 is further provided to shelter the passenger from weather and debris as well as provide additional safety. The housing 4 is preferably constructed of a lightweight, flexible yet durable material, such as a plastic or synthetic material, and optionally with a cover or screen or window to allow, for example, a passenger to view the user and the user to view the passenger while the carriage 2 is in motion. Although some level of transparency is desirable in a cover or screen, it is not necessary. In certain circumstances, such as during outdoor use, it may be desirable to have a housing 4 made from material(s) that filters ultraviolet light. Housing 4 may be composed of multiple layers of different transparency, which can be applied or removed based on conditions.

Therefore, according to various embodiments described herein, the assembly includes coupling members 14 having properties of a generally rigid members in tension and compression, but still allowing for some degree of flexibility and maneuverability. The contributions of coupling member 22 to the comfort of the passenger and the host, maneuverability of the carriage 2, and overall safety provide significant improvements over the prior art. One of ordinary skill will readily recognize a variety of materials that may be used to form the coupling members 14. By way of example, these materials may include, but are not limited to plastics such as polyethylene, polyurethane, ABS or other synthetic materials, or a more sturdy material such as steel, stainless steel, aluminum, brass, copper, nickel, and alloys of any of the aforementioned materials. In addition, although not shown in the drawing figures, the coupling members may be covered or coated by an additional material to improve aesthetic qualities and/or to prevent contact with structural components of the assembly described above. The covering material may be made from a variety of materials, including by way of example but not limitation, nylon, elastic material, semi-elastic material, neoprene, mesh, woven reinforced polyethylene, vinyl-coated polyester, vinyl-coated nylon, or vinyl laminated polyester.

This system allows for more efficient and safer carriage travel while also reducing the vibrations and undesired movement on the host, including oscillations that combine over time to create what is commonly referred to as the “pogo” effect. The various components/members described above act in series with each other to create an even, smooth and comfortable ride for the passenger. By further separating the carriage 2 from ground forces, the carriage travel remains as linear as possible. Specifically, vertical motion imparted to the carriage 2 is prevented from acting on various members and disturbing those forces to the host. Likewise, natural running or other motions by the host are not transferred to the carriage 2. One of ordinary skill in the art will recognize that typical shock absorption devices may also be incorporated to enhance this benefit.

The apparatus disclosed herein may be made of a variety of different materials. These materials may include, by way of example but not limitation, steel, stainless steel, titanium, titanium alloy, aluminum, aluminum alloy, chrome, chromium alloy, and other metals or metal alloys. These materials may also include, for example, wood, wood-filled composite, fiberglass, fiber-reinforced composite material, carbon fiber, ABS plastic, polyurethane, polyethylene, or one or more resins, particularly fiber-encased resinous materials rubber, latex, synthetic rubber, synthetic materials, polymers, and natural materials.

Those of skill in the art will understand how to make and use the present invention after understanding the present disclosure, including the variety of materials that would achieve the desired results. The present invention, in various embodiments, includes providing devices in the absence of items not depicted and/or described herein or in various embodiments hereof, including in the absence of such items as may have been used in previous devices or processes, e.g., for improving performance, achieving ease and\or reducing cost of implementation.

It should be noted that one of the ordinary skill in the art would recognize the intended host for this invention to include but not be limited to runners, walkers, rollerbladers, and other pedestrians who wish to incorporate a child into their activity. It should also be noted that the apparatus disclosed herein could be easily modified to couple to a user who is positioned on a bicycle, or alternatively coupled to the bicycle itself, without departing from the novel aspects disclosed herein. Furthermore, it is to be expressly understood that devices other than a carriage may be employed without departing from the novel aspects of the present disclosure for transporting objects other than a child, such as devices for carrying supplies, groceries, weights (for improving performance or training purposes), or other objects desired by the runner, cyclist, walker or other user.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. It is to be understood that certain aspects of the disclosure have utility apart from the combination with other aspects, or as an entire assembly. Thus, the following claims are hereby incorporated into this Detailed Description.

While various embodiments of the present invention have been described in detail, it is apparent that modifications and adaptations of those embodiments will occur to those skilled in the art. However, it is to be expressly understood that such modifications and adaptations are within the spirit and scope of the present invention, as set forth in the following claims.

1. An assembly for attaching a tow load to a user, comprising:
a harness;
at least one connection member affixed to the harness;
at least one dampening member associated with the at least one connection member, the at least one dampening member configured to dampen at least one of a horizontal, vertical or lateral force imparted on the at least one dampening member;
at least one coupling member selectively attachable to a tow assembly, the tow assembly configured to be coupled to the at least one connection member and thereby to the harness by selective attachment of the coupling member to the tow assembly and the at least one connection member.

2. The assembly according to claim 1 wherein the tow assembly is capable of pulling a tow load selected from the group consisting of a person, an animal, a cargo, a luggage, a backpack, a tank, a weight and a respiratory aid.

3. (canceled)

4. (canceled)

5. (canceled)

6. (canceled)

7. The assembly according to claim 1 wherein the harness is secured to a user by selectively engageable means, said selectively engageable means permitting the user to tighten or loosen the harness without removing the harness from the user's waist.

8. The assembly according to claim 7 wherein the harness may be positioned in a first position against the user to permit pulling of the tow load behind the user and a second position against the user to permit pushing of the tow load in front of the user.

9. (canceled)

10. (canceled)

11. The assembly according to claim 1 further comprising at least two connection members and at least two associated dampening members, wherein the at least two connection members and associated dampening members are located at substantially opposite portions of the harness.

12. The assembly according to claim 11 wherein the at least two dampening members are configured to dampen forces in a rotational direction relative to each of the associated at least two connection members.

13. The assembly according to claim 12 wherein the at least two dampening members are each comprised of a substantially cylindrical body positioned within a substantially cylindrical sleeve and further comprising at least two bearings positioned at each distal end of the substantially cylindrical body.

14. The assembly according to claim 11 further comprising at least one third connection member positioned substantially inbetween the at least two connection members and further comprising at least one associated dampening member configured to dampen forces in at least one of a horizontal and a vertical direction.

15. The assembly according to claim 1 further comprising at least two connection members and at least two associated dampening members, wherein the at least two connection members and associated dampening members are positioned in series, wherein the first of the at least two connection members is attached to the harness and the second of the at least two connection members is attached to the at least one coupling member, and wherein the at least two connection members and associated dampening members are configured to dampen forces in at least one of a horizontal and a vertical direction.

16. The assembly according to claim 15 wherein each of the at least two associated dampening members are comprised of at least a linear bearing.

17. The assembly according to claim 15 wherein each of the at least two associated dampening members are comprised of at least a spring.

18. The assembly according to claim 1 further comprising at least two connection members and at least two associated dampening members, wherein the at least two associated dampening members are each comprised of a post positioned substantially within a generally elliptical sleeve, and wherein the post is held within the generally elliptical sleeve by at least two biasing members in compression between the post and the generally elliptical sleeve.

19. The assembly according to claim 18 wherein the at least two associated dampening members are configured to dampen forces in a horizontal direction.

20. The assembly according to claim 18 further comprising at least one third connection member positioned substantially inbetween the at least two connection members and attached to the at least two connection members by an arcuate bridging member, wherein the at least one third connection member further comprises at least one associated dampening member configured to dampen forces in at least one of a horizontal and a vertical direction.

21. The assembly according to claim 1 wherein the at least one connection member, at least one dampening member and at least one coupling member are contained within a common housing.

22. The assembly according to claim 21 wherein the housing is comprised of a substantially hollow, spherical member having an opening in at least one portion for allowing the at least one coupling member to at least partially extend outside of the housing and be selectively attached to the tow assembly.

23. The assembly according to claim 22 wherein the at least one dampening member is comprised of at least a rotational spring, wherein the rotational spring permits dampening of forces in a rotational direction.

24. The assembly according to claim 22 wherein the connection between the at least one coupling member and the housing permits the user to pivot relative to the tow load, wherein the user is free to pivot about 60 degrees a first end pivot point to a second end pivot point.
